(19) United States
(12) Patent Application Publication
(10) Pub. No.: US 2019/0022463 A1
(43) Pub. Date: Jan. 24, 2019

(54) METHOD AND APPARATUS FOR ARCHITECTURE OF A KNOWLEDGE SYSTEM FOR MATHEMATIZATION OF KNOWLEDGE REPRESENTATION AND INTELLIGENT TASK PROCESSING

(71) Applicants: Nnamdi Emmanuel Iheakaram, South Orange, NJ (US); Chinna Krystal Iheakaram, South Orange, NJ (US); Emmanuel Ndidi Osegi, Rumuokania Port Harcourt (NG)

(72) Inventors: Nnamdi Emmanuel Iheakaram, South Orange, NJ (US); Chinna Krystal Iheakaram, South Orange, NJ (US); Emmanuel Ndidi Osegi, Rumuokania Port Harcourt (NG)

(21) Appl. No.: 16/037,237

(22) Filed: Jul. 17, 2018

Related U.S. Application Data
(60) Provisional application No. 62/534,212, filed on Jul. 19, 2017.

(51) Int. Cl. A63B 24/00; G05B 13/02; A63B 22/02

(52) U.S. Cl. CPC A63B 24/0087; G05B 13/028; A63B 22/025; A63B 2220/30; A63B 2230/062; A63B 2024/0093; A63B 24/0062

(57) ABSTRACT

An apparatus including a computer processor; a computer memory; an input sensor; a device, wherein the device includes a motor; and a set of software controllable vote switches, wherein an end user can vote in a judicial matter. The computer processor communicates with the computer memory, the input sensor or vote switches, and the device. The computer memory includes computer software for controlling the motor of the device in response to one or more inputs from the input sensor or controlling a set of vote switches in response to end user entries in a judicial matter. The computer program may cause the computer processor to select random data which is a subset of known data, and based on this random data and the one or more inputs from the sensor or vote switches, the computer processor controls the motor of the device or makes a decision on a judicial matter.

### CROSS REFERENCE TO RELATED APPLICATION(S)

This application claims the priority of U.S. provisional patent application, Ser. No. 62/534,212, filed on Jul. 19, 2017, inventor(s) and applicant(s), Nnamdi Emmanuel Iheakaram, Chinna Krystal Iheakaram, Emmanuel Ndidi Osegi, titled: “ARCHITECTURE OF A KNOWLEDGE SYSTEM FOR MATHEMATIZATION OF KNOWLEDGE REPRESENTATION AND INTELLIGENT TASK PROCESSING”.

### FIELD OF THE INVENTION

This invention relates to artificial intelligence systems.

### BACKGROUND OF THE INVENTION

A knowledge system (hereinafter KS) may be defined as a computer program for extending and querying a knowledge base. The knowledge base typically possesses specific information applicable to a particular domain but might also be constructed in a manner that affords domain independence.

Knowledge systems have evolved over time and with a variety of types and application areas with most knowledge systems having domain specific features. As discussed in U.S. Pat. No. 5,257,185, incorporated by reference herein, “Interactive, Cross-referenced Knowledge Systems” some examples of KS with domain specific features includes U.S. Pat. No. 4,591,983, incorporated by reference herein, describing a hierarchical KS for inventory control and processing orders and U.S. Pat. No. 4,648,037, incorporated by reference herein for end-user information retrieval and personal problem solving. However, the technique in U.S. Pat. No. 5,257,185, incorporated by reference herein, still requires a knowledge engineer to enter knowledge content into a knowledgebase.

All knowledge schemes mentioned above also lack a well defined knowledge representational scheme in addition to being restricted by the use of a human expert for knowledge entry.

More recent knowledge based systems employing state-of-the art real-time cortical learning algorithms such as in U.S. Pat. No. 2006/0184462, incorporated by reference herein “METHODS, ARCHITECTURE, AND APPARATUS FOR IMPLEMENTING MACHINE INTELLIGENCE AND HIERARCHICAL MEMORY SYSTEMS”, use data bits for knowledge representation and processing. In the aforementioned, knowledge is stored or memorized based on the requirement that an accumulation of active bits within several overlapping columns is a maximum at one or more winning columns meeting a threshold criteria.

Data bits however, have only two possible states which is insufficient for representing knowledge in its entirety—as knowledge is not simply true/false, 1/0 or ON/OFF states. This problem of knowledge definition and consequently its generation and representation remains a challenge for knowledge theorists, scientists and philosophers alike. Research in knowledge systems including its formulation and representations have also been interpreted in different ways and described using different theories. However, till this present date, no attempt has been made at devising a standard way of representing knowledge in a KS, not to mention its mathematization for real time applications.

More recently, an idea due to Rumsfeldian reasoning proposes a new school of thought that tries to capture the true essence of knowledge. For knowledge representation based on Rumsfeldian reasoning, a set of Known Known (KK), Known Unknown (KU) and Unknown Unknown (UU) things are defined. To further extend Rumsfeldian reasoning is to add an Unknown Known (UK) thing property giving a 4 state representation for knowledge.

In order to further the state-of-the-art in knowledge systems, a suitable KS representation would be very helpful. The current use of the bits as a unit for data representation in a KS is insufficient to deal with the true complexities inherent in knowledge and the many challenges faced by most KS warrants a better way of representing knowledge. More so, the bits representation though useful in most standard tasks, lacks depth and rigor for more complex tasks and cannot adequately and even approximately represent knowledge in sufficient detail. More recent research in knowledge theory has shown that knowledge exhibit several properties beyond simply true/false, ON/OFF or 1/0 states. It is therefore imperative to advance the state of knowledge representation in order to overcome the obvious limitations of current KS.

### SUMMARY OF THE INVENTION

In at least one embodiment of the present invention, a knowledge system is provided with an invariant architecture trainable by a real-time learning Artificial Intelligence (AI) expert program for diverse domain independent problem solving tasks. Specifically, the present invention discloses novel methods and architecture for representing knowledge in its entirety, reducing the dimensionality in data, encoding, storing and retrieving granular knowledge patterns continually learnt by an AI expert.

The present invention provides a Knowledge System (KS) for constructing a set of representative knowledge units herein called “granules”. The granules can be integrated as base units in real-time artificial (machine) intelligence (AI) expert systems learning framework obviating the use of binary (data bit) representation in online (continual) learning systems.

At least one embodiment of the present invention may be provided in two parts: The knowledge representation part which involves assigning numeric values to KS units and transformation to granules via a hierarchical granular decomposition operation.

The AI (artificial intelligence) learning part which learns samples of sequences from knowledge sources based on rules imposed on the aforementioned part.

In at least one embodiment, an apparatus is provided comprising a computer processor; a computer memory; an input sensor; and a device, wherein the device includes a motor.

The computer processor is typically in communication with the computer memory, the input sensor, and the device. The computer memory typically includes computer software for controlling the motor of the device in response to one or more inputs from the input sensor, and in accordance with a computer program stored in the computer memory. In at least one embodiment, the computer program causes the computer processor to select random data which is a subset of known data, and based on the random data and the one or more inputs from the sensor, the computer processor controls the motor of the device.

In at least one embodiment, the device is an exercise treadmill, and the motor controls the speed of the exercise treadmill; and wherein the input sensor is a heart rate sensor which measures the heart rate of a person or a walking speed sensor that measures the walking speed of a person.

In at least one embodiment, a method is provided which may include selecting random data as a subset of known data from a computer memory using a computer processor; receiving one or more inputs from an input sensor; and controlling a motor of a device based on the random data and based on the one or more inputs from the input sensor The device may be an exercise treadmill, and the motor controls the speed of the exercise treadmill; and wherein the input sensor is a heart rate sensor which measures the heart rate of a person or a walking speed sensor that measures the walking speed of a person.

### BRIEF DESCRIPTION OF THE DRAWINGS

FIG. 1 shows a simplified block diagram of an apparatus in accordance with an embodiment of the present invention;

FIG. 2 shows a simplified block diagram and/or semiotic square view explaining a method, apparatus, and/or process in accordance with an embodiment of the present invention and for use with the apparatus of FIG. 1;

FIG. 3 shows a flow chart of a method and apparatus in accordance with an embodiment of the present invention, and for use with the apparatus of FIG. 1;

FIG. 4A depicts a table and/or a comparative tabular view of Shannon data bits and the KS (knowledge system) units in linguistic terms;

FIG. 4B depicts an alternate view of the Shannon bits and KS units shown in FIG. 4A;

FIG. 4C depicts an intuitive numeric representation of the KS units;

FIG. 5 depicts a granulated view of FIG. 4C in a circle diagram including positive and negative phases of the KS units in percent granules;

FIG. 6 is a flow chart of a process to derive a KS representation;

FIG. 7 illustrates a possible interface with a real-time learning unsupervised AI expert;

FIG. 8 depicts a detailed KS representation flowchart including change events, search request, prevailing conditions, context information etc.

FIG. 9 illustrates alternative KS representation flowchart;

FIG. 10 illustrates a scheme for implementing a typical KS treadmill application;

FIG. 11 shows a simplified block diagram of a method, apparatus, and/or system in accordance with another embodiment of the present invention; and

FIG. 12 shows a simplified block diagram of a method, apparatus, and/or system in accordance with another embodiment of the present invention.

### DETAILED DESCRIPTION OF THE DRAWINGS

Architecture for developing a new form of Knowledge System (KS), mathematization of KS representations and intelligent task processing with the invented KS are disclosed. Subsequently, specific taxonomy and particulars is put forth to give a more thorough understanding of the present invention. However, it will be obvious to one especially experienced and well informed in the art that these specific details are not required in order to practice the present invention. For instance, the present invention describes an invariant knowledge representation scheme based on the Rumsfeldian reasoning and trained by an AI expert for memory predictions and decision making. Nevertheless, other knowledge representations and training systems may be used to make predictions and decisions. The numerous teachings of the present invention are put forth with reference to an illustrative practical reactive treadmill speed control system. However, the ideas set forth in the present invention can be applied to any type of knowledge mining task providing an environment with a regular source of information.

Knowledge is a very important part of human life and existence. Real human knowledge can be stored (memorized), retrieved and processed just like in most typical computer based knowledge systems.

However, the operations in real human knowledge systems are different from computer based systems. The origins and interpretations thereof have eluded knowledge theorists, scientists across all domains and field of endeavor for centuries.

In one hypothesis of human knowledge, there exists the concept of the mind and things that are known, unknown or supposedly known or unknown. In another hypothesis, there exists the schema which can exist in diverse forms and generate abstract levels of thoughts from low level schemas.

As earlier highlighted in the background, attempts at developing knowledge systems have been made by several researchers with promising applications. However, no attempt has been made at representing knowledge in a form and manner that yields a mathematization of knowledge components for use in real time processing applications.

As knowledge cannot be gained without reasoning and a thought process, it should be advantageous if a system exists that can afford to exercise such functions. More so, it is highly desirous if such a knowledge system can be mathematized for real-time decision making applications.

Knowledge can be described in terms of Known and Unknown units. Knowledge is generally composed of a set of vague representations; overtime these vague or fuzzy representations become more regular.

A thought process may be described in terms of a state of known and unknown events. When this is the case we may refer to the known events as a Known-Known or “KK” events and the Unknown as Unknown-Unknown or “UU” events.

In 2006, the US secretary of state, Donald Rumsfeld made a remarkable and novel statement. He stated that there are “Known Knowns, Known-Unknowns, and Unknown Unknowns”. Rumsfeld further stated that the Known Knowns refer to the things we know we know, the Known Unknown are things we know we don't know, and the Unknown Unknown are the things we don't know we don't know. A lot of real world observations give credence to this theory of knowledge representation.

In one instance, there is the desire phenomenon which may be described as a sequence of fantasies which is an image of real things. As a consequence of the aforementioned, experience teaches us that there are things we have learnt but we do not know we know them. This gives us a fourth assumption and representation of knowledge in the “Unknown-Unknown”.

In another instance, information search and hence knowledge discovery teaches us that there are things we know through a finding out or questioning process. This is one aspect of interrogative learning.

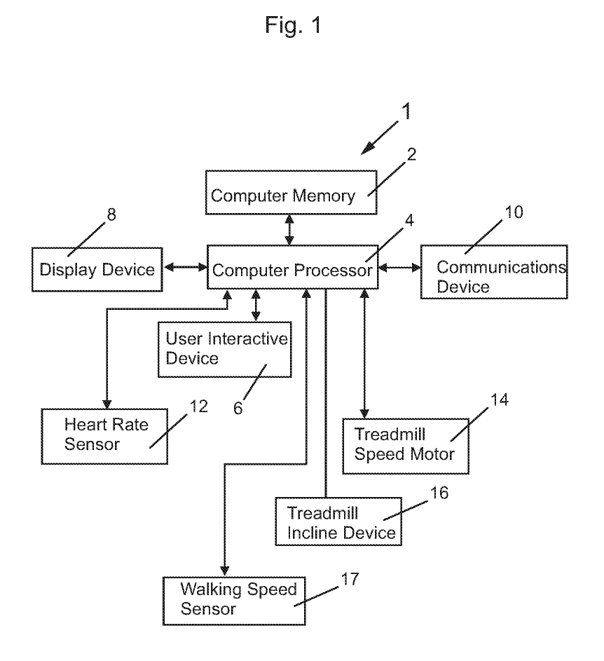

FIG. 1 shows a simplified block diagram of an apparatus 1 in accordance with an embodiment of the present invention. The apparatus 1 may include a computer memory 2, a computer processor 4, a user interactive device 6, a display device 8, a communications device 10, a heart rate sensor 12, a treadmill speed motor 14, and a treadmill incline device or motor 16. The components 2, 6, 8, 10, 12, 14, and 16 communicate with the computer processor 4 via communications links. The apparatus 1 may also include a walking speed sensor 17, which may be used, in at least one embodiment, as an input to the computer processor 4 to control the incline device 16 and/or the speed motor 14.

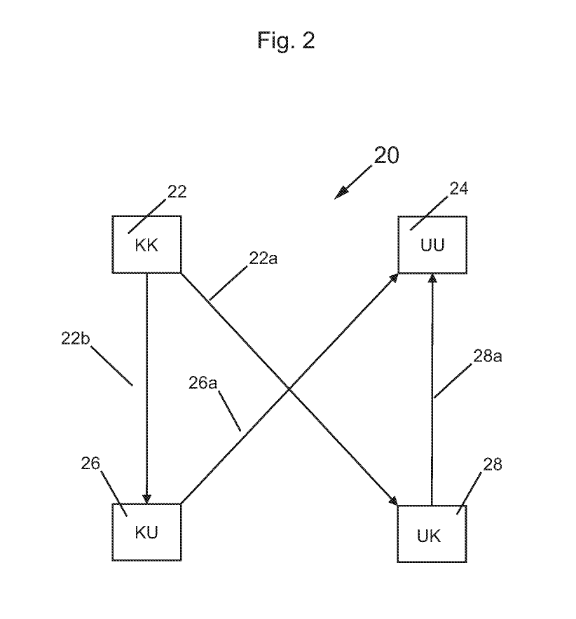

FIG. 2 shows a simplified block diagram 20 explaining a method, apparatus, and/or process in accordance with an embodiment of the present invention. The block diagram shows KK data 22 or known known data, UU data 24 or unknown unknown data, KU data 26 or known unknown data, and UK data 28 or unknown known data. KK data 22 may be data which is known and stored in computer memory 2 of FIG. 1. UK data 28 may be data which is randomly selected portion of the KK data 22 as shown by link 22a. KU data 26 may be data which is a randomly selected portion of the KK data 22 as shown by link 22b. UU data 24 may be data which is randomly derived from both the KU data 26 and the UK data 28 as shown by links 26a and 28a.

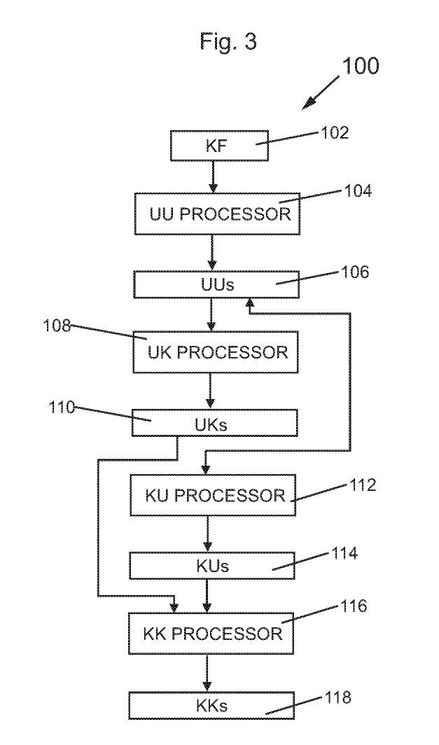

FIG. 3 shows a flow chart of a method and apparatus 100 in accordance with an embodiment of the present invention.

Block or module 102 indicates a collection of data which may be called a “Knowledge Field” or KF, and which may correspond to the KK data 22. For example, in at least one embodiment, the collection of data may be an array of fifty rows by three columns as shown for the Knowledge Field, KF, for the sample computer program from LINE 21 to before LINE 22, as shown at the end of this detailed description of invention.

Each row of the fifty rows of the knowledge field has a number indicating heart rate of a person on an exercise treadmill in a first column, a number indicating the incline of the exercise treadmill in a second column, and a number indicating the speed of the treadmill in a third column. For example, the first row in the sample program of the KF field indicates “150” (which is for beats per minute), “0” (which is for a zero degree inclination), and “3.6” (which is a measure of speed of the treadmill belt). The sample computer program may be stored in the computer memory 2 and executed by the computer processor 4. The fifty rows by three columns of data may be stored in the computer memory 2. Each row, represents data at a specific instance in time. The fifty rows show fifty different instances in time for the same treadmill. The data may be chronological. For example, the first row may be at a first time, and the next rows may be at increments of one second thereafter.

The collection of data of module 102 of FIG. 3, which may be the fifty rows of the sample computer program, may be stored in the computer memory 2 of FIG. 1.

Block or module 104 indicates UU (or Unknown-Unknown) data processor 104. The UU processor 104 may be implemented by or part of the computer processor 4 and programmed by a computer program stored in computer memory 2. The UU processor 104 may be programmed by computer software stored in the computer memory 2 to search through the data in KF module 102 and to select only a percentage of the plurality of samples (each sample includes all three field, i.e. each sample include a heart rate, an inclination, and a speed at a particular instant of time) of the KF module 102 to form UUs at module 106 which are designated as UUs or Unknown-Unknowns. The UU data may be stored in the computer memory 2. Generally, all of the plurality of samples of module 102 are categorized as being unknown to the knowledge part of the computer processor 4. I.e. although all of the plurality of samples in module 102 are stored in the computer memory 2, and accessible to the computer processor 4, the plurality of samples of module 102 are still categorized as unknowns. In addition, which samples of the module 102 are selected by the random process are also categorized as unknown. The selection process for UUs may be a random selection process.

The UUs are a percentage of the plurality of samples of the KF module 102, and are supplied to the UK processor 108. The UK processor 108 may be part of the computer processor 2 and/or may be programmed by computer software stored in the computer memory 4.

The UK processor 108 uses an experiential learning rule based on a Euclidean difference or Hebbian memory conditioning to select a percentage of the samples of the KF module 102 or a percentage of samples of the UUs to form UKs at module 110 which are a percentage of the plurality of samples in the KF module 102. Also, the UKs are designated as UKs and stored in computer memory 2.

The KU processor 112 uses a query rule based on prefix search and/or end-user requests with Euclidean difference conditioning to select a percentage of the samples of KF module 102 or a percentage of samples of the UUs to form KUs at module 114 which are a percentage of the plurality of samples of the samples in the KF module 102. Also the KUs are designated as KUs and stored in the computer memory 2.

The UKs and KUs are supplied to the KK processor 116. The KK processor 116 may be part of the computer processor 4 and/or implemented by the computer memory 2. The KK processor 116 may produce KKs which are a percentage of the plurality of samples of the samples in the KF module 102. Also, the KKs are designated as KKs and stored in the computer memory 2.

The method of FIG. 3 produces UUs, UKs, KUs and KKs, as designated in computer memory 2, which are used for desiring an available knowledge source field, synthesizing knowledge from an experiential process, synthesizing knowledge from a questioning process, and synthesizing a knowledge field respectively.

In the sample computer program shown at the end of this detailed description, the UUs are granular portions of the KF representing the portion of the desired information or data source, the KUs are granular portions of the UUs or KF representing the information sources derived from a query or questioning operation, and the UKs are granular portions of the UUs or KF representing the information sources derived from an experiential operation.

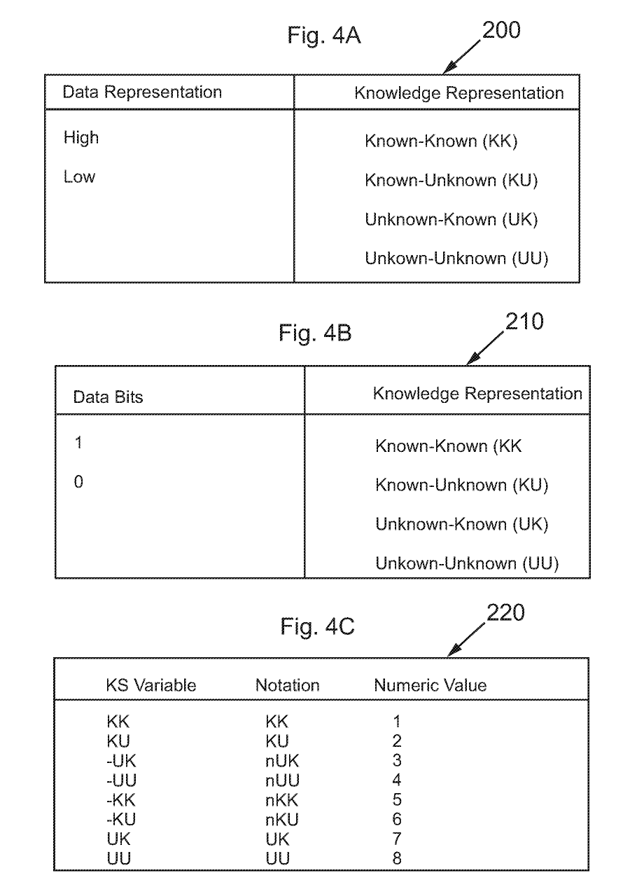

FIGS. 4A-4C show tables 200, 210, and 22, respectively, regarding data used in the apparatus 1 in accordance with an embodiment of the present invention. FIG. 4A depicts a table and/or a comparative tabular view of Shannon data bits and the KS (knowledge system) units in linguistic terms. FIG. 4B depicts an alternate view of the Shannon bits and KS units shown in FIG. 4A. FIG. 4C depicts an intuitive numeric representation of the KS units.

Each of the tables 200 and 210, has two columns. The first column has three rows and the second column has five rows. The tables 200 and 210 indicate that Known-Known (KK) data has a representation of high and 1, and that Known-Unknown (KU), Uknown Known (UK), and Unknown Unknown (UU) data have a representation of low and 0, respectively.

Table 220 shown in FIG. 4C has three columns. Table 220 indicates that the KS (knowledge system) Variables KK, KU, UK, −UU, KK, −KU, UK, and UU, have a notation of KK, KU, nUK, nUU, nKK, nKU, UK, and UU and a numeric value of 1, 2, 3, 4, 5, 6, 7, and 8, respectively, all of which may be stored in computer memory 2 of the apparatus 1 of FIG. 1.

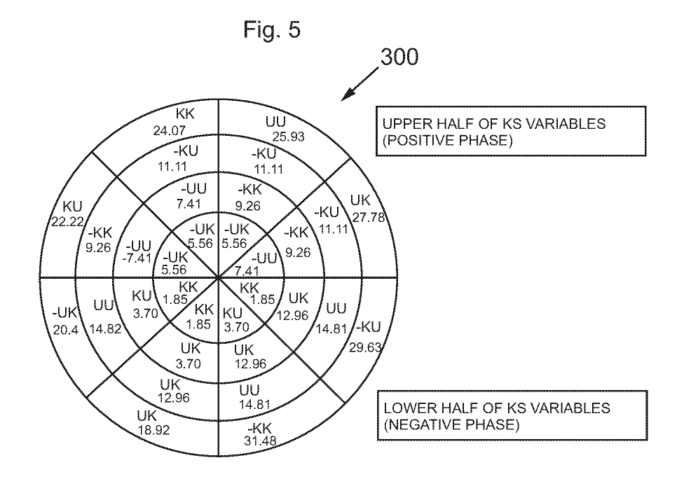

FIG. 5 shows a chart 300 for data in accordance with an embodiment of the present invention. FIG. 5 depicts a granulated view of FIG. 4C in a circle diagram including positive and negative phases of the KS units in percent granules.

The top semicircle of the chart 300 shows the upper half of KS (knowledge system) variables for a positive phase, and the bottom semicircle of the chart 300 shows the lower half of the KS (knowledge system) variables for a negative phase. The numbers in the chart are all derived using principles of granular computing. The numbers shown in FIG. 5 may be stored in computer memory 2.

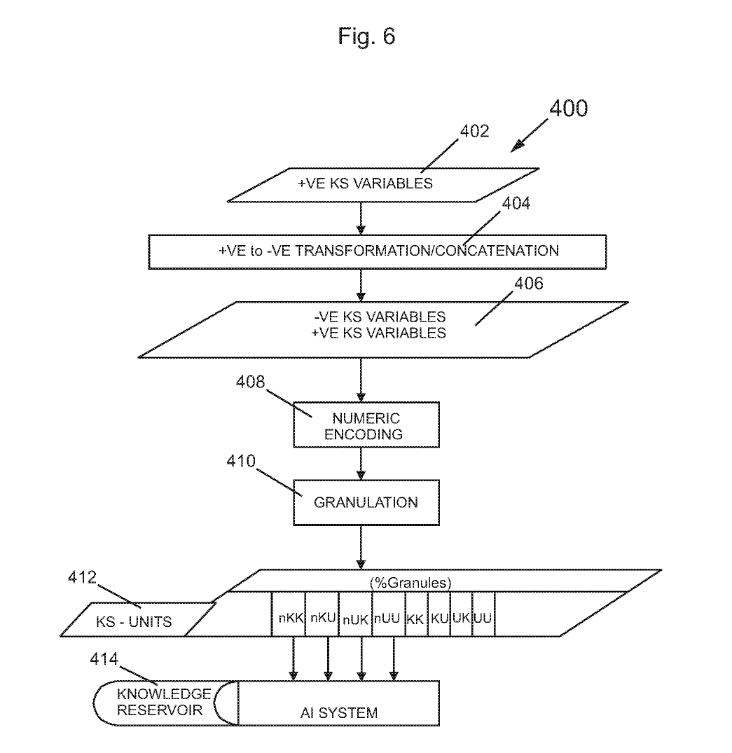

FIG. 6 shows a flow chart 400 of another method and apparatus in accordance with an embodiment of the present invention, and for use with the apparatus 1 of FIG. 1 FIG. 6 is a flow chart of a process to derive a KS representation.

FIG. 6 depicts a flow diagram for deriving a KS (knowledge system) representation of states by use of computer processor 4, by a computer program stored in computer memory 2, also herein called the ‘knowledge granules’. As can be observed with one moderately skilled in the art of data conversion, this task can be accomplished, the computer processor 4, in relatively short duration and also easily. In one or more embodiments a transformation of positive KS variable states at step 402 into negative KS variable states is accomplished, and then both positive KS and negative KS are concatenated into a single form at step 404.

Note that VE in FIG. 6 represents and/or implies a positive state, and −VE represents and/or implies a negative state.

Specifically, in one or more embodiments of the present invention, transformations are computed and concatenated from a base (positive) KS variable state by a mathematization process, stored in computer memory 2, and implemented by computer processor 4 into a definite ordered sequence of positive and negative KS states at step 406.

More specifically, in one or more embodiments, numeric encoding at step 408 is used, by the computer processor 4 to derive the aforementioned, and then granulation at step 410 is used to further derive a well defined set of KS granules at step 412.

Furthermore, in one or more embodiments of the present invention, KS granules are trained by a sequence of machine intelligent algorithms in a memory prediction framework within an AI system within the computer processor 4; the KS granules themselves also define the rules for portioning memory states into a knowledge reservoir at step 414.

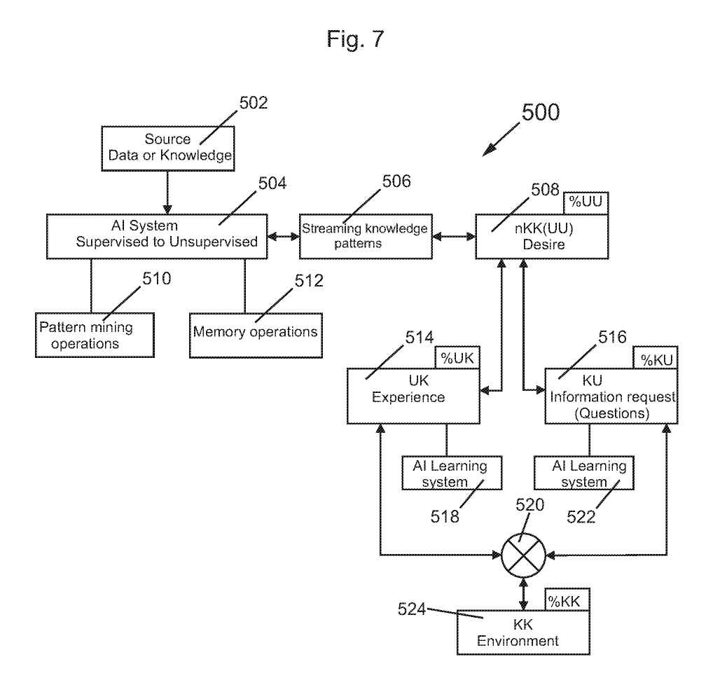

FIG. 7 shows a flow chart 500 of another method and apparatus in accordance with an embodiment of the present invention, and for use with the apparatus 1 of FIG. 1. FIG. 7 illustrates a possible interface with a real-time learning unsupervised AI expert.

FIG. 7 deals with dimensionality reduction. As can be observed, an AI system may be supervised or unsupervised use a set of pattern mining and memory operations to synthesize a sequence of streaming knowledge patterns from a data or knowledge source. Streaming knowledge patterns may be decoded by a desire (UU) thing in a predetermined manner and at a pre-defined percentage in units of KS granules. Thus, the (UU) thing is a representation of a desire phenomenon in percent granules. Subsequently, UK states (units) are derived sparsely in percent KS granules from the UU in an experiential manner; in a similar manner KU states (units) are derived sparsely in percent KS granules from the UU via a questioning phase.

Furthermore, in one or more embodiments of the present invention, machine intelligent learning can be used to make the UK experience and the KU questioning more sparse and predictive. These sparse units can then be mixed to form KK states (units) rich in knowledge granules.

At step 502 source data or knowledge, such as KF knowledge or fifty rows by three columns of data as shown in the sample computer program may be determined or stored in computer memory 2. The KF knowledge may be provided to AI system Supervised or Unsupervised at step 504 to extract and memorize data patterns.

The AI system, which may be implemented by the computer processor 4 executing computer software stored in the computer memory 2, may implement pattern mining operations 510 such as intelligent search and retrieval of knowledge from data, and memory operations 512, such as storage of the knowledge so obtained.

The AI system which may be implemented by the computer processor 4 executing computer software stored in the computer memory 2, may implement streaming knowledge patterns at step 506, and nKK(UU) desire, or a percentage of KK may be provided as UU at step 508. A percentage of UU may be provided as UK at step 514, and a percentage of UU may be provided as KU at step 516 by action of the computer processor 4 implementing computer software stored in computer memory 2. The AI learning system 518 and 522 may implement the UK or experience step 514 using standard machine intelligence operations such as Euclidean difference match and/or Hebbian learning and the KU or information request (questions) step 516 using standard prefix search or Euclidean difference search.

KK information may be provided to block 520, which distributes a percent of KK as UK at step 514 and a percent of KK as KU at step 516, as determined by computer software stored in the computer memory 2 and executed by the computer processor 4.

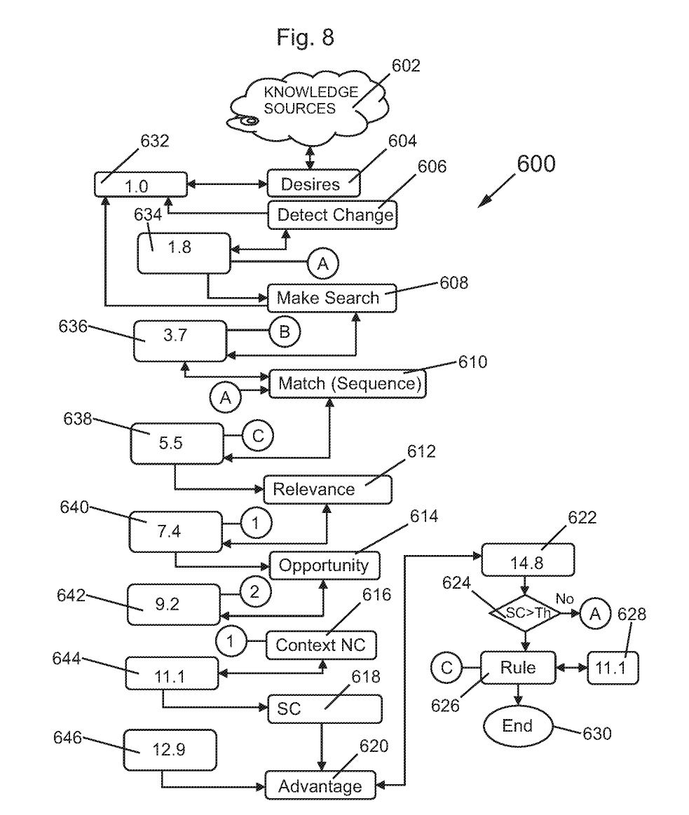

FIG. 8 shows a flow chart of another method and apparatus 600 in accordance with an embodiment of the present invention, and for use with the apparatus 1 of FIG. 1. FIG. 8 depicts a detailed KS representation flowchart including change events, search request, prevailing conditions, context information etc.

FIG. 8 deals with the KS (knowledge system) as a service.

It is possible to put the KS in service using a sequence of knowledge operations (call this KSaaS). This is detailed in the flowchart of FIG. 8. In FIG. 8, a series of processing is taken care of by the computer processor 4, as programmed in the computer memory 2, by knowledge operation blocks and where necessary corresponding states are encoded numerically in a block. In the context of the present invention, a state is a meta-granular numeric representation of a knowledge operation. In one or more embodiments of the present invention, the entire sequences of operations are coordinated using control blocks.

In the flowchart of FIG. 8, desires 604 are obtained from a knowledge field or source 602 and encoded at step 632 or 1.0. A detect change request at step 606 is made on the encoded desires 604 by the computer processor 4 and the resulting effect encoded at step 634 or 1.8. In addition a control point (A) is set at the detect change encoding point by the computer processor 4 in the computer memory 2. If we make a search on the encoded desires (1.0) or 632 in computer memory 2 using the resulting change (1.8) or 634 we derive a search encoding (3.7) or step 636 controlled at set point (B). Using (A) as reference input and the search encoding as monitoring input, the computer processor 4 obtains the Match or Match (sequence) and stores this in computer memory 2.

The Match (or Match sequence) is encoded (5.5) or step 638 by the computer processor 4 in the computer memory 2 and this encoding is set at control point (C). A Relevance operation is then used by the computer processor 4 to determine in the first instance if the desire from desires 604 (and hence the match) was actually meaningful or needed. The Relevance encoding or step 640 (7.4) is set at control point (1). The Opportunity or 614 in turn determines over time the likelihood of the occurrence of a search or match i.e. if the match is relevant, the Opportunity is increased at 614 otherwise it is reduced. The Opportunity encoding at step 642 or (9.2) is set at control point (2).

Finally, in order to generate a universal rule, a necessary condition (NC) at step 616 and a sufficient condition (SC) at step 618 is required by the computer processor 4. The necessary condition (NC) at step 616 takes as context a desire instance (e.g. war or peace) as indicated by (1) or 632 and this further gives us the SC or step 618. An Advantage may be pre-computed to further describe the necessary benefits for Rule formulation. The Advantage is defined by a stationary encoding (12.9) at step 646 and a transition encoding at step 622 or (14.8); the transition encoding feeds into a decision block conditioned by SC or step 618 and a threshold (Th) at step 624. If the SC meets the predefined threshold, at step 624 the Rule is formed by concatenating the match encoding at point (C), at step 626, with the Context NC encoding and the entire knowledge processing terminates; otherwise, a detect change and search operation is repeated as indicated by (A).

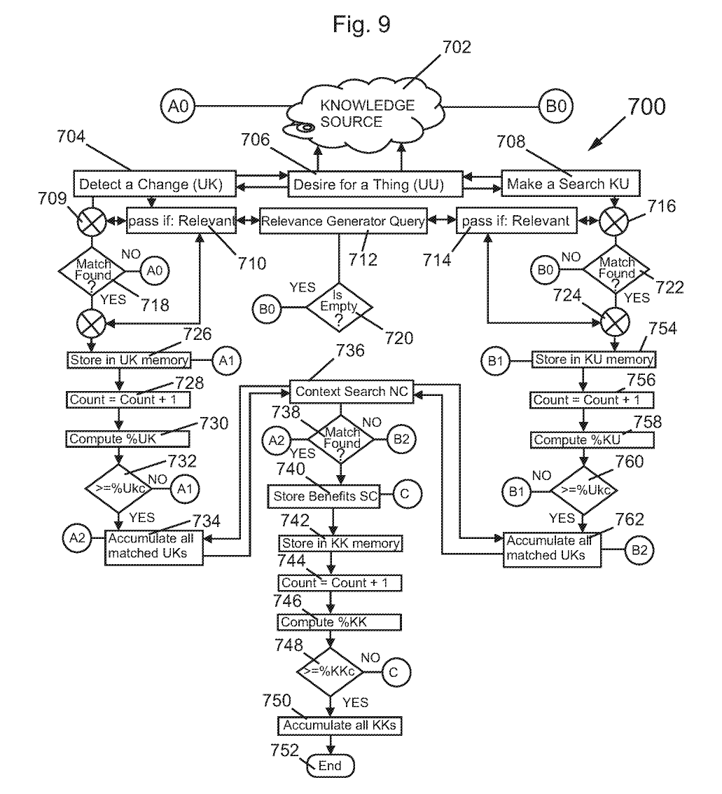

FIG. 9 shows a flow chart of another method and apparatus in accordance with an embodiment of the present invention, and for use with the apparatus of FIG. 1. FIG. 9 illustrates alternative KS representation flowchart.

FIG. 9 shows an alternative KSaaS to FIG. 8.

In FIG. 9, is shown a flowchart 900 of an alternate KS representation as a service. In the flowchart, A0 and B0 represent key control (or source) points for accessing an imaginary knowledge field in the UK and KU reference frames respectively. In the same vein, A1 and A2 represent key control points for a UK experience while B1 and B2 represents corresponding control points for KU questioning. C in turn represents the control point for accessing the benefits at the KK stage. All operations are performed for a period of time defined by an incremental counter.

As indicated in the flowchart 900 of FIG. 9, a desire for a thing at step 702 from knowledge source 702 is defined by a UU block taking the UK (at step 704) and KU (at step 708) reference into account.

In the first instance, a UK and KU block is used to detect a change in desire and make a desire search, at step 704 and at 708 respectively using appropriate machine intelligence, through use of computer software stored in computer memory 2 and implemented by computer processor 4.

A logical operator block is then used by computer processor 4 to determine if the change or search is relevant, at step 712 when compared to a relevance query obtained from a Relevance Generator Query (RGQ) block. If a match is found, at steps 718 and 722, respectively, both UK and KU data is passed to next operator block, otherwise the desire for a thing operation from the knowledge field is performed again as indicated by (A0, B0). If the RGQ block at step 712 returns an empty query at step 720, a desire for a thing operation is also performed (B0).

In the second instance, a store operation is performed on UK and KU data as defined by control points (A1) and (B1) respectively if they meet a relevance requirement coordinated by a second set of operator blocks. For a certain number of time steps, the aforementioned operations are repeated to obtain a rich UK/KU memory sequence store in computer memory 2. Then granular amounts of matched UKs and KUs are accumulated at steps 734 and 762, respectively, as indicated by (A2/B2) if they meet a predefined threshold (% UKc, % KUc) at steps 732 and 760 respectively, otherwise the store operation process is repeated as indicated by (A1/B1).

In the third instance a context search NC at step 736 is performed between the accumulated UKs and KUs and if a matches are found at step 738, the computer processor 4 as programmed by computer software stored in the computer memory 2, stores the benefits as an SC (indicated by control point, C) in KK designated memory in computer memory 2; otherwise the aforementioned operations are repeated. For each count operation at step 744, a granular portion of KK (% KK) is extracted at step 746 and passed over to a decision block at step 748. If % KK is greater than a threshold say, % KKc, all KKs are accumulated at step 750 and the entire operation ends at step 752 otherwise a store benefits operation is repeated by the computer processor 4 as indicated by control point (C).

In the previous sections, a Knowledge System (KS) composed of a novel representation of knowledge and that can be integrated into or composed of a machine intelligence memory prediction system for control and decision making have been introduced and explained. This system is indeed a Knowledge System (KS) different from others that attempts to bridge the gap between the origin or structure of knowledge and its pragmatic application—indeed a bridge between theory and practice of variety of knowledge operations thereof. In this section, an example embodiment of the KS that uses the teachings of the previous sections to intelligently control the speed of a treadmill is presented. Indeed, the actual implementation of the KS may be represented by a non-physical model such as a logical program, microcomputer/microprocessor software program stored in computer memory 2 and implemented by computer processor 4, or a microcontroller program etc, as long as the principles of the teachings in the aforementioned sections are adhered to.

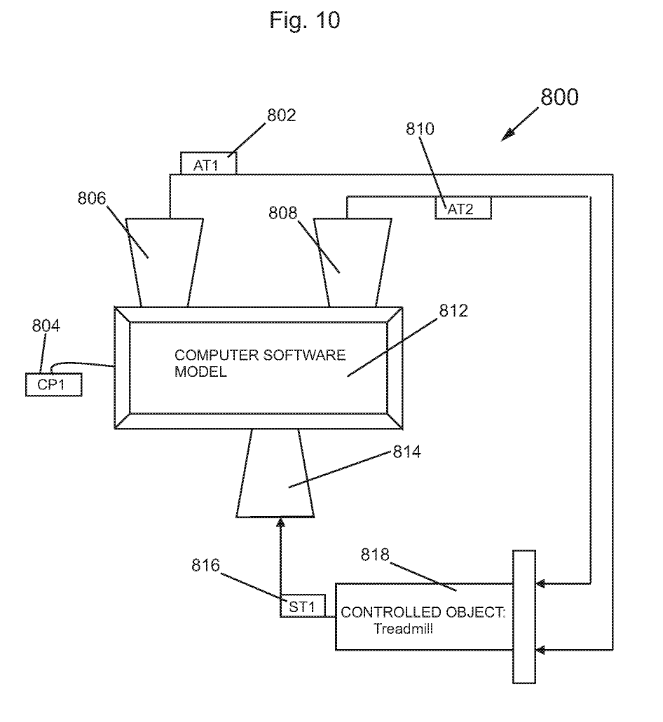

In a proposed KS Treadmill application, the connections are set forth as shown in FIG. 10. comprising an input sensor link (ST1) or 816, two output control links (AT1, AT2) or 802 and 810 and a computer software model or 812 which may be stored in computer memory 2 and executed by computer processor 4 of FIG. 1. The input link ST1 or 816 describes a heart rate sensor line feed to a heart rate sensor, which may be similar or identical to heart rate sensor 12 shown in FIG. 1, and the control links describe the speed and gradient (slope) control line feeds, which may be connected to a treadmill speed motor and to a treadmill incline device such as 16 and 14 in FIG. 1. The computer software model 812 describes a computer software program implementation, such as in computer memory 2 of the KS that allows the Treadmill (physical model) or 818 to operate optimally for a comfortable user experience.

In order to implement the KS Treadmill, a PC-interface or a microcontroller interface may be employed, such as by using computer processor 4. For the PC (personal computer) based application, a generative procedure is used, in at least one embodiment, to obtain an KF (knowledge field) of >=1000 samples (which may be said to be equivalent to an area of 50*20 squares). Each sample is a concatenation of the velocity (speed), gradient and heart rate, where the first two are control parameters of treadmill, such as through device 16 for incline and 14 for speed or velocity, and the last one the corresponding sensing parameter such as through heart rate sensor 12. For the embedded microcontroller application in computer memory 2, a sample size of about fifty is just sufficient to demonstrate the applicability of the KS model.

It will be pertinent with one moderately skilled in the art of logic comprehension and control theory to note that with the KS architecture, there is no need to set any desired heart rate level. The KS (knowledge system) which is executed by the computer processor 4 implementing computer software stored in computer memory 2, learns from the input data through experiences and search queries (it's questioning phase) via the aforementioned composed knowledge representations. For example, when a novel input or heart rate request is made, it goes through the KU KS module which makes a search of about % KU of the UK experiences. The UK experiences are derived by the UK KS module executed by the computer processor 4 by applying a relevance cortical-like overlapping learning rule to about % UK of the UU desires or data sources. The desire (UU) sources are generated from UU module executed by the computer processor 4 by intelligently selecting pseudo-randomly a % UU of the KF. Finally, a % KK of results of the KU operation are stored in the KK module of the computer memory 2 from which a candidate pattern is pseudo-randomly selected and the first two inputs used as the interpreted winner control signals for the treadmill. The procedure for implementing such a scheme is illustrated by the sample computer software program at the end of this description.

A physical computing view of a prototype digital-electronic circuitry for actualizing the KS model task described in the previous section is as shown in FIG. 1. The circuitry includes the key components required for operating the KS-treadmill including an electric motor for the treadmill 14 and a servo motor for the inclination of the treadmill 16 acting as actuators, a belt drive component (not shown would be connected to 14), a heart rate sensor 12, an embedded microcomputer/microcontroller unit, which may include computer processor 4 and computer memory 2, and which contains the necessary internal control program (firmware) is included to coordinate the activities of most of the other components.

To operate (control) the treadmill experientially, the computer processor 4 receives command sensory signals from the heart rate sensor 12, then uses stored data (describing a KF or knowledge field) in computer memory 2, to generate explanatory control signals for activating actuators or motor 14 and motor 16. The motor 14 controls the speed based on the inferred control (speed) pattern; also the motor 16 or device 16 controls the elevation (inclination) if a request for this function is made.

The entire process is repeated as long as the user of the treadmill decides to continue with the training otherwise the simulation is halted automatically—this is made possible by the training pattern and by a sample firmware such as described in FIG. 1.

The following is a sample computer program, with comments, as previously referred to which can be stored in the computer memory 2 and implemented by the computer processor 4.

SAMPLE COMPUTER PROGRAM (and comments) regarding at least one embodiment:

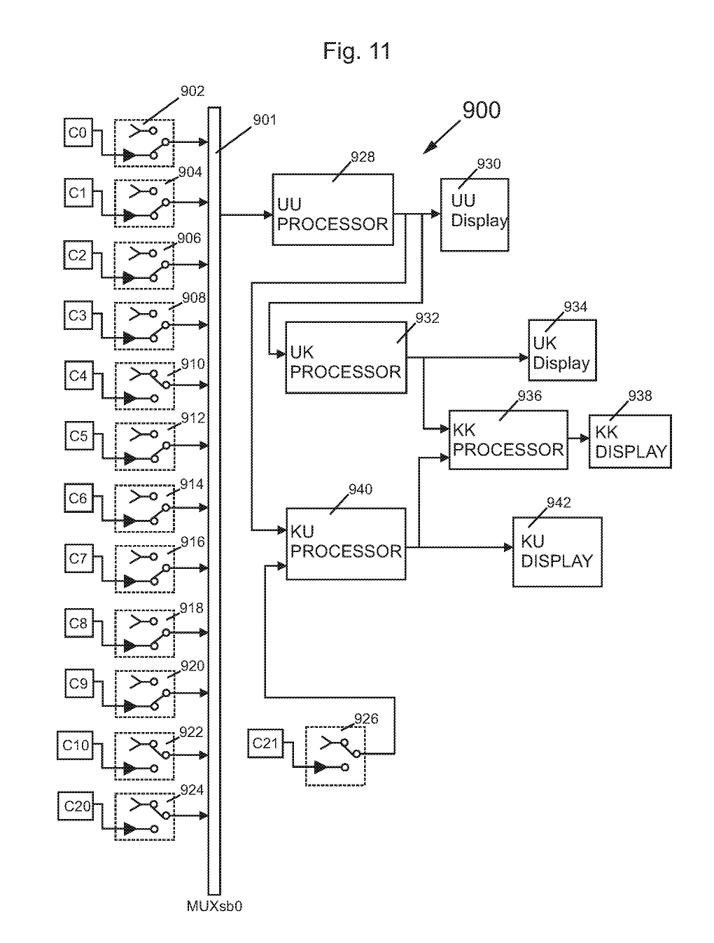

FIG. 11 shows a simplified block diagram 900 of a method, apparatus, and/or system in accordance with another embodiment of the present invention.

The diagram 900 shows constants C0, C1, C2, C3, C4, C5, C6, C7, C8, C9, C10, C20, and C21. These are model blocks used for initializing software process blocks in the MATLAB-SIMULINK language. MATLAB generally, is known MATrix LABoratory computer software and SIMULINK is generally a known graphical programming environment.

The diagram 900 shows switches 902, 904, 906, 908, 910, 912, 914, 916, 918, 920, 922, 924, and 926. The diagram 900 shows modules for the UU processor 928, UK processor 932, KK processor 936, and KU processor 940, all of which may be part of the computer processor 4 of FIG. 11, and may implement computer software stored in the computer memory 2 of FIG. 11. The diagram 900 further shows UU display 930, UK display 934, KK display 938, and KU display 942, all of which may be part of display device 8 shown in FIG. 11.

In a related application, an adaptive/dynamic real time software implementation of the KS in a fair judicial process is shown implemented by the method, process, and apparatus shown by diagram 900 of FIG. 11. The software application is implemented using the MATLAB modeling language called SIMULINK. The connections are set forth as shown in FIG. 11 comprising primarily of an input set of voting switches 902-924 and any further number of voting switches, an embedded function block of computer software stored in the computer memory 2, describing the UU processor 928, an embedded function block of computer software stored in computer memory 2, describing the UK processor 932, another embedded function block of computer software stored in computer memory 2 describing the KU processor 940, and a subsystem block (KK state out) describing the KK processor 936.

The input voting switches 902-924 and any further number of switches describe a sequence of inputs similar to the process of voting in a fair electoral process but encoded as 1 in agreement with a judgment or judicial opinion and a 0 in disagreement with the judicial opinion. Each switch of switches 902-924 allows the entry of a vote in favor (signal a 1) or against (signal a 0) the judicial opinion by a member of a population of participants in the judicial process. These entries, may be stored in computer memory 2, through multiplexer 901. These entries give rise to, or make up a Knowledge Field (KF) sequence similar to that of the Treadmill application.

The embedded function block of UU processor 928 operates in accordance with the principles set forth earlier in the Treadmill application. In this UU processor 928, a portion of the voting data is extracted, as programmed by computer software, from the generated KK vote field data at MUXsb0 identified as multiplexer 901 shown in FIG. 11 and randomly pooled to give rise to the UU vote sequence set which may be stored in the computer memory 2. The sample embedded software code implementation of the UU processor 928 with comments is as set forth below:

| | |
|---|---|
| LINE1. | function UU_values = fcn(u) |
| LINE2. | %% Knowledge Field Sub-routine |
| LINE3. | KF = u; |
| LINE4. | n_E = numel(KF); %MATLAB function that Computes the number of elements in |

KF

| | |
|---|---|
| LINE5. | %% UU Processor Sub-routine |
| LINE6. | sd = n_E;% Standard deviation of the distribution |
| LINE7. | uo = 1;%Mean of the distribution: default is 1 |
| LINE8. | UU_per = 31; %Percent value of KF extracted by the UU processor |
| LINE9. | UU_sample = fix((UU_per*n_E)/100);% Computed Granular value of the UU |
| LINE10. | rand_UU = fix((rand(n_E,1).*sd) + uo);%Try fix, ceil or floor (compatible with |

embedded matlab function block)

| | |
|---|---|
| LINE11. | UU_idx_selected = rand_UU(1:UU_sample,1);%Selected UU indices |
| LINE12. | UU_values = KF(UU_idx_selected,1); |

The embedded function block, UK processor 932, operates in accordance with the principles set forth earlier in the Treadmill application. In this UK processor 932, as programmed by computer software stored in computer memory 2, a portion of the voting data is extracted from the UU data (which is produced at the output of the UU processor 928 shown in FIG. 11) and randomly pooled to give rise to the UK vote sequence set at the output of the UK processor 932, which may be stored in computer memory 2. Then this set (UU) passes through an experiential operator LINES 21-25 based on the Euclidean distance metric to generate the UK prediction set. The sample embedded software code implementation of the UK processor 932 with comments is as set forth below:

| | |
|---|---|
| LINE1. | function UK_values_match_predictions = fcn(u) |
| LINE2. | % This block supports the Embedded MATLAB subset. |
| LINE3. | % See the help menu for details. |
| LINE4. | %% Knowledge Field Sub-routine |
| LINE5. | UU = u; |
| LINE6. | n_E = numel(UU); %MATLAB function that Computes the number of elements in |

KF

| | |
|---|---|
| LINE7. | %% UK Processor Sub-routine |
| LINE8. | sd = n_E;% Standard deviation of the distribution |
| LINE9. | uo = 1;%Mean of the distribution: default is 1 |
| LINE10. | UK_per = 30; %Percent value of KF or UU extracted by the UK processor |
| LINE11. | Th = 0.2; % Threshold value for a sufficient condition |
| LINE12. | UK_sample = fix((UK_per*n_E)/100);% Computed Granular value of the UK |
| LINE13. | rand_UK = fix((rand(n_E,1).*sd) + uo);%Try fix, ceil or floor (compatible with |

embedded matlab function block)

| | |
|---|---|
| LINE14. | UK_idx_selected = rand_UK(1:UK_sample,1);%Selected UK indices |
| LINE15. | UK_values = UU(UK_idx_selected,1); |
| LINE16. | n_E_UK_values = numel(UK_values); |
| LINE17. | UK_values_match_idx = ones(n_E_UK_values,1); |
| LINE18. | UK_values_n = UK_values(n_E_UK_values); % Extracts the current(nth)UK value |
| LINE19. | euclid_diff = abs(UK_values_n - UK_values); |
| LINE20. | % UK_values_match_idx = find(euclid_diff==0); |
| LINE21. | for i = 1:n_E_UK_values |
| LINE22. | if(euclid_diff(i)==0) |
| LINE23. | UK_values_match_idx(i) = i; |
| LINE24. | end |
| LINE25. | end |
| LINE26. | UK_values_match_predictions = UK_values(UK_values_match_idx,1);%Extract |

the UK predictions using the indexes.

The embedded function block KU processor 940, also operates in accordance with the principles set forth earlier in the Treadmill application. In this processor 940, a portion of the voting data is extracted from the UU processor 928 and randomly pooled to give rise to the KU vote sequence set. Then this set (KU) passes through an experiential operator LINES 19-23 which is also based on the Euclidean distance metric to generate the KU prediction set. In light of the present invention, the KU processor uses an external query or interrogative signal (query_in) as context in the current time step for deriving its predictions or representations LINE 17. The sample embedded software code implementation of the KU processor 940 with comments is as set forth below:

| | |
|---|---|
| LINE1. | function KU_values_match_predictions = fcn(u,query_in) % query_in |

represents the interrogative signal

| | |
|---|---|
| LINE2. | %% Knowledge Field Sub-routine |
| LINE3. | UU = u; %The KF field can also come from UU: **Take Note |
| LINE4. | n_E = numel(UU); %MATLAB function that Computes the number of elements in |

KF

| | |
|---|---|
| LINE5. | %% KU Processor Sub-routine |
| LINE6. | sd = n_E;% Standard deviation of the distribution |
| LINE7. | uo = 1;%Mean of the distribution: default is 1 |
| LINE8. | KU_per = 20; %Percent value of KF or UU extracted by the KU processor |
| LINE9. | Th = 0.2; % Threshold value for a sufficient condition |
| LINE10. | KU_sample = fix((KU_per*n_E)/100);% Computed Granular value of the KU |
| LINE11. | rand_KU = fix((rand(n_E,1).*sd) + uo);%Try fix, ceil or floor (compatible with |

embedded matlab function block)

| | |
|---|---|
| LINE12. | KU_idx_selected = rand_KU(1:KU_sample,1);%Selected UK indices |
| LINE13. | KU_values = UU(KU_idx_selected,1); |
| LINE14. | n_E_KU_values = numel(KU_values); |
| LINE15. | KU_values_match_idx = ones(n_E_KU_values,1); |
| LINE16. | %KU_values_n = KU_values(n_E_KU_values); % Extracts the current(nth)KU |

value; Not Used

| | |
|---|---|
| LINE17. | euclid_diff = abs(query_in - KU_values); |
| LINE18. | %KU_values_match_idx = find(euclid_diff==0); |
| LINE19. | for i = 1:n_E_KU_values |
| LINE20. | if(euclid_diff(i)==0) |
| LINE21. | KU_values_match_idx(i) = i; |
| LINE22. | end |
| LINE23. | end |
| LINE24. | KU_values_match_predictions = KU_values(KU_values_match_idx,1); |

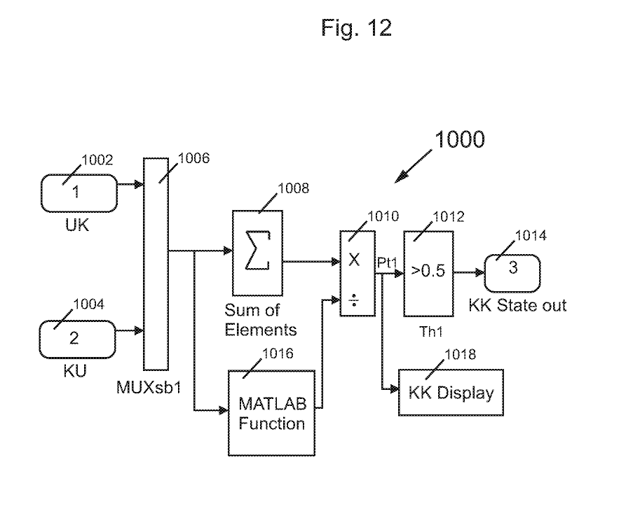

FIG. 12 shows a simplified block diagram 1000 of a method, apparatus, and/or system in accordance with another embodiment of the present invention being a subsystem of FIG. 11.

The diagram 1000, shows components 1002, 1004, 1006, 1008, 1010, 1012, 1014, 1016, and 1018.

In this diagram 1000, the KK processor receives processed knowledge fields (vote signals) from the UK processor at UK (or 1002) and the KU processor at KU (or 1004) and then concatenates UK with KU at MUXsb1 (or 1006) forming a field of decision signals. The decision signals emanating from 1006 are summed up using a summation block or module (Sum of Elements) 1008 and then divided by the cardinality of the signals formed at 1006. The cardinality of the signals at 1006 is computed by a MATLAB function block 1016 by setting its function property field to “numel”. The division operation 1010 gives a probabilistic interpretation of KK at point Pt1 which is then compared to a threshold block, Th1 (or 1012) set to a critical value of 0.5. The resulting KK decision signal is then sent out of the subsystem for further signaling using an outport block KK state out (or 1014). Display, KK Display (or 1018) gives an indication of the signal at Pt1.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

We claim:

1. An apparatus comprising:
a computer processor; and
a computer memory;
wherein the computer memory has stored therein a real time computer software program including a set of software vote switches that is configured to be executed by the computer processor to allow a set of end users to vote in a judicial process; and
wherein the real time computer program causes the computer processor to select random data which is a subset of known data, and based on one or more inputs from the software vote switches, the computer processor makes decisions on a judicial matter.

2. A method comprising
selecting random data as a subset of known data from a computer memory using a computer processor;
receiving one or more inputs from an input sensor;
receiving one or more inputs from software controllable vote switches;
controlling a motor of a device based on the random data and based on the one or more inputs from the input sensor; and
making decisions based on the random data and based on the one or more inputs from the vote switches.

3. An apparatus comprising:
a computer processor;
a computer memory;
an input sensor;
and a device, wherein the device includes a motor;
wherein the computer processor is in communication with the computer memory, the input sensor, and the device;
wherein the computer memory includes computer software for controlling the motor of the device in response to one or more inputs from the input sensor, and in accordance with a computer program stored in the computer memory; and
wherein the computer program causes the computer processor to select random data which is a subset of known data, and based on the random data and the one or more inputs from the sensor, the computer processor controls the motor of the device.

4. The apparatus of claim 3 wherein
the device is an exercise treadmill, and the motor controls the speed of the exercise treadmill; and
wherein the input sensor is a heart rate sensor which measures the heart rate of a person.

5. The apparatus of claim 3 wherein
the device is an exercise treadmill, and the motor controls the speed of the exercise treadmill; and
the input sensor is a walking speed sensor which measure the speed of the exercise treadmill.

6. A method comprising
selecting random data as a subset of known data from a computer memory using a computer processor;
receiving one or more inputs from an input sensor; and
controlling a motor of a device based on the random data and based on the one or more inputs from the input sensor.

7. The method of claim 6 wherein
the device is an exercise treadmill, and the motor controls the speed of the exercise treadmill; and
wherein the input sensor is a heart rate sensor which measures the heart rate of a person.

8. The method of claim 6 wherein
the device is an exercise treadmill, and the motor controls the speed of the exercise treadmill; and
the input sensor is a walking speed sensor which measure the speed of the exercise treadmill.
